(19) United States
(12) Patent Application Publication
(10) Pub. No.: US 2025/0089709 A1
(43) Pub. Date: Mar. 20, 2025

(54) CALCIUM PHOSPHATE NANOPARTICLES LOADED WITH JASMONATE TO INDUCE EFFICIENT PLANT DEFENCE RESPONSES

(71) Applicant: UNIVERSIDAD DE GRANADA, Granada (ES)

(72) Inventors: José Manuel DELGADO LÓPEZ, Granada (ES); Gloria Belén RAMÍREZ RODRÍGUEZ, Granada (ES); Belén PARRA TORREJÓN, Granada (ES)

(21) Appl. No.: 18/290,763

(22) PCT Filed: Jul. 21, 2022
(86) PCT No.: PCT/EP2022/070463

§ 371 Date: Jan. 20, 2024

(30) Foreign Application Priority Data
Jul. 21, 2021 (EP) 21382662.1

(51) Int. Cl. A01N 37/10; A01N 25/12; A01P 21/00

(52) U.S. Cl. CPC A01N 37/10; A01N 25/12; A01P 21/00

(57) ABSTRACT

The present invention relates to a composition comprising calcium phosphate nanoparticles loaded with a jasmonate compound. In addition, the invention relates to a method for preparing the composition of the invention as well as the composition obtainable by said method. Finally, the invention relates to a method for inducing a jasmonate-dependent eliciting response in a plant.

### FIELD OF THE INVENTION

The present invention is comprised within the field of biotechnology. It specifically relates to nanoparticles loaded with a jasmonate compound and its use as agriculture.

### BACKGROUND OF INVENTION

The use of pesticides and agrochemicals has resulted in a noticeable increase in the food production and crop yields over the last decades. However, more than 99% of applied pesticides are either lost in the surrounding environment or unable to reach the target area due to leaching, evaporation, deposition and/or degradation by photolysis, hydrolysis and microbial activity. Owing to these losses, the concentration of active ingredients in the pesticides is far below the minimum effective concentration and, repeated applications are thus required. This indiscriminate usage causes significant environmental damage such as water pollution, soil contamination, increased pets and pathogen resistance and loss of biodiversity, among others.

As an alternative, the self-protection mechanisms that plants have evolved against biotic and abiotic stresses are being used as a source of inspiration to develop eco-friendly formulations. Elicitors induce structural and/or biochemical responses associated with the expression of plant disease resistance and have been proposed as potential alternatives for effective management of plant diseases. Among them, methyl jasmonate (MeJ) or its acidic derivative (jasmonic acid) are hormones, widely found in plant kingdom, involved in plant signaling.

Jasmonates able to trigger plant defense responses, is a natural and clean alternative to the use of hazardous pesticides. One of the defence mechanisms of plants against pests and pathogens consists on the production of low molecular mass secondary metabolites (i.e., phytoalexins) with antimicrobial activity, such as anthocyanins, stilbenes, and flavonols. These phenolic compounds are also the major responsible of the organoleptic properties of wine and grapes, including wine colour, mouth feel properties and aging potential and stability In addition. Nonetheless, the enrichment of wines in beneficial polyphenols requires high concentration of MeJ (ca. 10 mM) to be applied through the leaves during veraison. Unfortunately, the low water solubility, thermal stability and phytotoxicity of MeJ limit its efficient applicability and particularly at such high concentration. In fact, previous field experiments confirmed that the foliar application of 10 mM MeJ was needed to promote stilbene production in grapes and wines. Nonetheless, MeJ at high rates can exert toxicity in plants. Concentrations ranging from 5 to 20 mM caused serious cucumber leaf damages such as propagation of necrotic lesions whereas acute MeJ concentrations (50 mM) led to the activation of programmed cell death and subsequent rapid propagation of necrosis over the entire leaf surface (Jiang, Y et al, J. Exp. Bot. 2017, 68 (16), 4679-4694).

Therefore, smart materials able to protect the elicitor and prolong its retention on leaves surface are needed to provide a sustained and more efficient administration.

### SUMMARY OF THE INVENTION

The authors of the invention have found that calcium phosphate nanoparticles loaded with MeJ are able to increase the content of beneficial compounds (phytoalexins) in grapes and wines. These nanoparticles protect and retain MeJ on the surface of plant leaves during long period of times. This protective action along with the slow release provides a prolonged supply of the resistant-inductor elicitor, resulting in a significant efficiency increase. Additionally, the nanocomposites are stable during long periods (more than 175 days) and exhibit lower cytotoxicity than free MeJ, important features for the efficient and safe usage in agriculture.

Thus, in a first aspect the invention relates to a composition comprising calcium phosphate nanoparticles loaded with a jasmonate compound.

In a second aspect, the invention relates to a method for preparing a composition according to the invention comprising:
a) contacting a composition A comprising a calcium salt with a composition B comprising a phosphate under conditions adequate for the formation of a precipitate formed by calcium phosphate nanoparticles;
b) collecting the precipitate obtained in step a),
c) dispersing the precipitate obtained in step b) in an aqueous solvent and
d) contacting the dispersion obtained in step c) with a jasmonate compound

In a third aspect, the invention relates to a composition obtainable by the process as defined in the first aspect of the invention.

In a final aspect, the invention relates to method for inducing a jasmonate-dependent eliciting response in a plant which comprises applying a composition according to the first or third aspects of the invention to the plant, to a propagule thereof or to the soil in which the plant is grown.

### DESCRIPTION OF THE FIGURES

FIG. 1. UV-Vis spectrum (a) and calibration curve (b) of methyl jasmonate in H₂O and H₂O/EtOH. Dashed lines represent the best fits of the experimental data according to equation 1 for H₂O and equation 2 for H₂O/EtOH.

FIG. 2. Graphical sketch of the nano-MeJ preparation consisting in two steps: (i) ACP precipitation and (ii) MeJ adsorption on ACP nanoparticles.

FIG. 3. (a) FTIR spectra and (b) XRD patterns of ACP nanoparticles (nano-control) and nano-MeJ synthesized with increasing MeJ concentrations (nano-MeJ10, nano-MeJ20, nano-MeJ40 and nano-MeJ200). (c) MeJ adsorption efficiency for nano-MeJ40 and nano-MeJ20.

FIG. 4. FTIR spectrum of MeJ showing the most intense absorption band at 1740 cm-1 corresponding to carbonyl (ketone) groups.

FIG. 5. TEM micrograph of nano-MeJ showing the same morphology than control ACP nanoparticles. The amorphous nature of the particles is confirmed by the lack of diffraction spots in the selected-area electron diffraction (SAED) pattern (inset).

FIG. 6. Long-term stability of nano-MeJ upon storage. (a) FTIR spectra of nano-MeJ sample stored at 4° C. for up to 0, 49, 126, 175 and 363 days. The spectra were normalized by the maximum intensity (at ca. 1030 cm-1) and vertically offset for sake of clarity. (b) Area ratio of the bands associated to MeJ and calcium phosphate (A1740/A1033) as a function of storage time (days). The intervals used to estimate the area are highlighted in (a).

FIG. 7. XRD patterns of nano-MeJ sample freeze-dried at time 0, 49 and after 363 days. XRD patterns after 49 and 363 days of storage show two broad Bragg peaks at around 26° and 32° (2θ) ascribed to hydroxyapatite (HA, ASTM card file No 09-432).

FIG. 8. (a) Effects of MeJ, nano-MeJ and ACP nanoparticles (nano-Control) on B16-F10 cell viability. Data are expressed as mean with their corresponding standard deviation as error bars. Statistically significant differences between treatments are marked with * (P-value<0.05) or *** (P-value<0.001). Cell viability versus log of MeJ concentration (b) showed lower IC50 values for nano-MeJ samples.

FIG. 9. MeJ release profile from nano-MeJ in aqueous media. Dashed line represents the best fits of the experimental data to the first order equation: y(t)=a*(1−e−kt), being the rate constant, k=0.04 h-1. The inset shows the linearized experimental data (symbols) and the first order equation (line).

FIG. 10. Concentration (mg L-1) of total stilbenes (a), t-resveratrol (b) and c-resveratrol (c) in wines from grapes treated with water solutions containing 5 mM (MeJ5) and 10 mM (MeJ10) of MeJ, and nano-MeJ with a total concentration of 1 mM. Results of grapes treated with naked nanoparticles (nano-Control) and non-treated grapes (control) are also shown. Data are expressed as mean with their corresponding standard deviation as error bars. Statistically significant differences between measurements are marked with * (P-value<0.05), ** (P-value<0.01) or *** (P-value<0.001).

FIG. 11. (a) t-piceid and (b) c-piceid concentration (mg L-1) in wines from grapes treated with MeJ (5 mM, MeJ5, and 10 mM, MeJ10) and nano-MeJ with a total concentration of 1 mM. Results of grapes treated with ACP nanoparticles (nano-Control) and non-treated grapes (control) are also shown. Data are expressed as mean with their corresponding standard deviation as error bars. Statistically significant differences between measurements are marked with * (P-value<0.05), ** (P-value<0.01) or *** (P-value<0.001).

FIG. 12 (a) Optical micrographs of drops containing MeJ (top) and nano-MeJ (bottom) collected at different time intervals at 50° C. Scale bar=100 μm. (b) Percentage of remaining MeJ (quantified by UV-vis spectroscopy) after 24 hours at 50° C. for both treatments. (c) Pictures of grapevine leaves collected several hours after being sprayed with MeJ10 (top) and nano-MeJ (bottom). (d) Graphical sketch of the evolution of MeJ and nano-MeJ in the aqueous droplets after spraying the leaves.

FIG. 13. Raman spectroscopy micro-analysis of the surface after 24 hours of depositing NanoMeJ and stored at 50° C. The spectrum of the sample 10 mM MeJ (no signal) is also shown. Asterisks indicate Raman peaks associated to MeJ.

### DETAILED DESCRIPTION OF THE INVENTION

The present invention relates to the provision of new nanoelicitors and their use in inducing a jasmonate-dependent eliciting response in plants.

Compositions Comprising Calcium Phosphate Nanoparticles Loaded with a Jasmonate Compound

In a first aspect, the invention relates to a composition comprising calcium phosphate nanoparticles loaded with a jasmonate compound.

As used herein, “calcium phosphate” refers to a family of minerals containing calcium ions (Ca2+), together with orthophosphates (PO₄³⁻), metaphosphates or pyrophosphates (P₂O₇⁴⁻) and hydrogen or hydroxide ions. As used herein, “calcium phosphate” specifically includes amorphous calcium phosphate (ACP), hydroxyapatite (Ca₁₀(PO₄)₆(OH)₂), tricalcium phosphate (Ca₃(PO₄)₂), calcium metaphosphate (Ca(PO₃)₂), fluorapatite (Ca₁₀(PO₄)6F₂), chlorapatite (Ca₁₀(PO₄)6Cl₂) and the like. The composition of the invention may comprise a single type of calcium phosphate alone or a combination of two or more.

As used herein, the term “loaded” is used to define that the jasmonate compound can be adsorbed or absorbed on the surface of the particle or encapsulated on the particle. In some embodiments, a compound of interest can be absorbed/adsorbed on the outer surface of a preformed nanoparticle in order to form a coating of the compound of interest on the outer surface of the nanoparticle.

“Adsorption”, as used herein refers to a surface process, the accumulation of a gas or liquid on a liquid or solid. Adsorption can be defined further based on the strength of the interaction between the adsorbent (the substrate onto which chemicals attach) and the adsorbed molecules. Adsorption can be physical or chemical. Physical adsorption or physisorption implies van der Waals interactions between substrate and adsorbate (the molecule that is adsorbed); chemical adsorption or chemisorption involves chemical bonds (covalent bonds usually) in sticking the adsorbate to the adsorbent. Chemisorption involves more energy than physisorption. The difference between the two processes is loosely based on the binding energy of the interaction.

“Absorption”, as used herein refers to a phenomenon involving the bulk properties of a solid, liquid or gas. It involves atoms or molecules crossing the surface and entering the volume of the material. As in adsorption, there can be physical and chemical absorption.

“Physical absorption” refers to a non-reactive process e.g. when oxygen present in air dissolves in water. The process depends on the liquid and the gas, and on physical properties like solubility, temperature and pressure. “Chemical absorption” refers to a chemical reaction that takes place when the atoms or molecules are absorbed.

The term “encapsulated” or “nanoencapsulation” is defined as the technology of packaging nanoparticles of solid, liquid, or gas, also known as the core or active, within a secondary material, named as the matrix or shell, to form nanocapsules. The core contains the active ingredient (e.g., the jasmonate compound) while the calcium phosphate shell isolates and protects the core from the surrounding environment. This protection can be permanent or temporal, in which case the core is generally released by diffusion or in response to a trigger, such as shear, pH, or enzyme action, thus enabling their controlled and timed delivery to a targeted site.

In a preferred embodiment the jasmonate compound is adsorbed in the surface of the calcium phosphate nanoparticle.

The term “jasmonate compound” or “jasmonates (JAs)” refers to compounds characterized by a cyclopentanone ring which are known as plant stress hormones produced by plants facing a stressful situation. JAs are formed from α-linolenic acid (α-LeA) of chloroplast membranes by oxidative processes occurring in different branches of the lipoxygenase pathway. Consequently, JAs are members of the family of oxylipins. Among the most prominent plant hormones active in stress responses is jasmonic acid (JA). “Jasmonic acid” or “jasmonate” is an oxo monocarboxylic acid that is (3-oxocyclopentyl)acetic acid substituted by a (2Z)-pent-2-en-1-yl group at position 2 of the cyclopentane ring.

The compounds mentioned herein may contain a non-aromatic double bond and one or more asymmetric centers. Thus, they can occur as racemates and racemic mixtures, single enantiomers, individual diastereomers, diastereomeric mixtures, and cis- or trans-isomeric forms. All such isomeric forms are contemplated. For example, the jasmonate compound described herein includes all of any optical isomer that is based on the asymmetric carbon and is optically pure, any mixture of various optical isomers, or racemic form. Examples of stereoisomers of MDJ include, for example, (1R,2R)-dihydromethyljasmonate, (1R,2S)-dihydromethyljasmonate, (1S,2R)-dihydromethyljasmonate, and (1S,2S)-dihydromethyljasmonate. Examples of isomers of methyljasmonate include cis- or trans(1R,2R)-methyljasmonate, cis- or trans-(1R,2S)-methyl jasmonate, cis- or trans-(1S,2R)-methyljasmonate, and cis- or trans-(1S,2S)-methyl jasmonate.

The jasmonate family can be modified in its structure to improve his actions towards innumerous different aims. It can be changed in its cyclopentanone ring, increasing or making substitutions, turning it to cyclopentenone, or adding innumerous other elements to its structure to improve its effects. The Jasmonates family elements can also be used to formulate new compound to be included with it inside of the nano, and or, microcarriers.

In a particular embodiment, the jasmonate compound is selected from the group consisting of jasmonic acid, 7-iso-jasmonic acid, 9,10-dihydrojasmonic acid, 9,10-dihydroisojasmonic acid, 2,3-didehydrojasmonic acid, 3,4-didehydrojasmonic acid, 3,7-didehydrojasmonic acid, 4,5-didehydrojasmonic acid, 4,5-didehydro-7-isojasmonic acid, cucurbic acid, 6-epi-cucurbic acid, 6-epi-cucurbic acid-lactone, 12-hydroxy-jasmonic acid, 12-hydroxy-jasmonic acid-lactone, 11-hydroxy-jasmonic acid, 8-hydroxy-jasmonic acid, homo-jasmonic acid, dihomo-jasmonic acid, 11-hydroxy-dihomo-jasmonic acid, 8-hydroxydihomo-jasmonic acid, tuberonic acid, tuberonic acid-0-P-glucopyranoside, cucurbic acid-0-P-glucopyranoside, 5,6-didehydro-jasmonic acid, 6,7-didehydro-jasmonic acid, 7,8-didehydro-jasmonic acid, cis-jasmone, dihydrojasmone, and a lower alkyl ester thereof.

In a preferred embodiment, the jasmonate compound is methyl jasmonate (MeJ).

The term, “methyl jasmonate (MeJ)” or “jasmonic acid methyl ester” as used herein refers to a jasmonate ester with molecular formula C₁₃H₂₀O₃ that is the methyl ester of jasmonic acid. It has a role as a member of jasmonates, a plant metabolite and a plant hormone. It is a jasmonate ester and a methyl ester.

Thus, for example, reference to a jasmonate compound may include not only a single jasmonate but also a combination or mixture of two or more different jasmonates including pro drugs, esters, salts, metabolites thereof.

It is not necessary for every nanoparticle to comprise a compound of interest. Only a subset of the nanoparticles may comprise the jasmonate compound. For example, at least 2%, at least 5%, at least 10%, at least 20%, at least 30%, at least 40%, at least 50%, at least 60%, at least 70%, at least 80%, at least 90%, at least 95%, or 100% (i.e. all of the nanoparticles) of the nanoparticles can comprise the jasmonate compound. In some embodiments, not all of the nanoparticles comprise the jasmonate compound.

In a particular embodiment, the ratio of the calcium phosphate nanoparticles and the jasmonate compound is between 1:1 and 20:1 (w/w).

In a preferred embodiment, the ratio of the calcium phosphate nanoparticles and the jasmonate compound is 10:1 (w/w).

In a particular embodiment, the calcium phosphate is amorphous calcium phosphate (ACP) and the nanoparticles further comprise a citric acid derivative and a carbonate.

The term “amorphous calcium phosphate” or “ACP” is used to refer to a unique species among all forms of calcium phosphate in that it lacks long-range, periodic atomic scale order of crystalline calcium phosphates. This means that ACP can be recognized from its broad and diffuse X-ray diffraction pattern with a maximum at 25 degrees 2 theta, and no other different features compared, with well crystallized hydroxyapatite. Additionally or alternatively, amorphous calcium phosphates may be characterized as calcium phosphate materials in which analysis by XRD shows the typical broad band peaking at approximately 31 2-theta and extending from 22 to 36 2-theta. ACP is formed from spherical ion clusters called Posner clusters (characteristic diameter 9.5 A) and approximately 20 wt % of tightly bound water.

The ACP of the invention include compounds with chemical formula Ca₃(PO₄)₂·nH₂O and Ca/P molar ratio with a range of 1.34-1.50 in different pH and 1.50-1.67 when adding different amount of carbonates. In addition, the ACP of the invention also includes APC with HPO₄²⁻ ions instead of PO₄³⁻, leading to a lower Ca/P ratio, as low as 1.15.

Calcium phosphate nanoparticles comprise an amorphous calcium phosphate phase as small as 1 nm and as large as 250 nm, preferably between 1 nm and 250 nm, between 1 nm to 150 nm, between 1 nm and 75 nm, between 5 nm to 250 nm, between 5 to 150 nm, between 5 to 75 nm, between 10 to 250 nm, between 10 to 150 nm, between 10 to 100 nm, between 10 to 75 nm, between 10 to 50 nm, between 10 to nm, preferably between 40 and 100 nm in diameter.

Methods for the production of ACP are known in the art and typically imply the mixing of a calcium salt and a phosphate. Alternatively, the present document provides, as a second aspect of the invention, a method of preparing calcium phosphate nanoparticles, and more specifically, ACP.

As used herein, “citric acid”, also known as 2-hydroxypropane-1,2,3-tricarboxylic acid or anhydrous citric acid is a tricarboxylic acid that is propane-1,2,3-tricarboxylic acid bearing a hydroxy substituent at position 2. A particularly suitable citric acid derivative is a water-soluble alkali metal salt of citric acid, typically the lithium, potassium or sodium salt. It is preferred to use the sodium salt. Trisodium citrate dihydrate is particularly preferred.

The kind of the citric acid derivative is not particularly limited as long as it is a known citric acid derivative. For example, the citric acid derivative may be at least one selected from the group consisting of acetyl triethyl citrate, diethyl citrate, tributyl citrate, triethyl citrate, and acetyl tributyl citrate.

That is, the citric acid derivative may be contained in an amount between 1% and 10% w/w based on the total weight of the nanoparticle loaded with the jasmonate compound.

In a particular embodiment, the citric acid derivative is sodium citrate (Na₃Cit).

As used herein, a carbonate is a salt of carbonic acid (H₂CO₃), characterized by the presence of the carbonate ion, a polyatomic ion with the formula of CO₃²⁻.

The carbonate salt may be contained in an amount between 0.1 and 7% w/w based on the total weight of the nanoparticle loaded with the jasmonate compound.

In a particular embodiment, the carbonate salt is sodium carbonate.

In a particular embodiment the citric acid derivative is sodium citrate (Na₃Cit) and the carbonate salt is sodium carbonate (Na₂CO₃).

In a preferred embodiment the ACP represents at least 80%, at least 85%, at least 90%, at least 95%, at least 96%, at least 97%, at least 98% or at least 99% of the calcium phosphates of the composition of the invention.

In another embodiment the hydroxyapatite represents at least 80%, at least 85%, at least 90%, at least 95%, at least 96%, at least 97%, at least 98% of at least 99% of the calcium phosphates of the composition of the invention.

“Hydroxyapatite” (HAp), as used herein, is a basic calcium phosphate represented by the chemical formula Ca₁₀(PO₄)₆(OH)₂, which is known to be present in nature as the main component of bones and teeth, and to exhibit high biocompatibility.

Hydroxyapatite is the hydroxyl endmember of the complex apatite group. The OH− ion can be replaced by fluoride, chloride or carbonate, producing fluorapatite or chlorapatite. It crystallizes in the hexagonal crystal system. Hydroxyapatites are synthesized by various methods and utilized in various fields, including biomaterials. The manufacturing methods thereof include a solution method (wet process), which is a method of synthesis by reacting a calcium ion and a phosphate ion in a neutral or alkaline aqueous solution at room temperature. Representative methods include those using a neutralization reaction and those using a reaction of a salt and a salt. HAp synthesized by the above approaches is amorphous, so that sufficient stability cannot be guaranteed depending on the intended use. Thus, it can be preferable to further sinter HAp to enhance the crystallinity.

Hydroxyapatites may be spherical or rod-shaped. Examples of such products include SHAp (calcined hydroxyapatite nanoparticles) sold by SofSera, which are sold as, for example, spherical or rod shaped particles.

The average particle size of the calcium phosphate other that ACP is about 100 to about 400 nm.

As used herein, “average particle size” is the average diameter of particles when referring to the calcium phosphate of the present invention. Numerical values measured as follows are used herein as an average particle size. As used herein, “diameter” refers to “average particle size”, unless specifically noted otherwise. A scanning electron microscope (SEM) is used for measuring an average particle size herein.

As used herein, “spherical” and “substantially spherical” are interchangeably used. For hydroxyapatites, those with a ratio of the shortest diameter to the longest diameter of target particles of less than 2 are referred to thereby. “Spherical” and “substantially spherical” include completely spherical as well as shapes that are somewhat non-spherical. Plus and minus “spherical” and “substantially spherical” hydroxyapatites generally coexist. They are also called “substantially spherical” in the art, but “spherical” and “substantially spherical” are used synonymously for the present invention.

As used herein, “rod-shaped” (rod-like=rod) refers to so-called stick-like hydroxyapatites in addition to non-spherical hydroxyapatites when used for hydroxyapatites, referring to those with a ratio of the shortest diameter to the longest diameter of target particles of about 2 or greater. “Rod-shaped” hydroxyapatites are generally divided into plus (side surface) and minus (cross-section). Although not wishing to be bound by any theory, it is explained that a rod-shaped cross-section (c face) exposes many oxygen atoms from phosphate ions, and a rod-shaped side surface (a face) exposes many calcium atoms, and charges from each atom (ion) results in a difference in the distribution of plus/minus in rod-shapes and spheres (Kawasaki et al., European Journal of Biochemistry 152, 361-371 (1985)).

In a particular embodiment, when the composition comprises a combination of at least two or more calcium phosphates, the at least two calcium phosphates are ACP and hydroxyapatite. In another embodiment, when the at least two calcium phosphates are ACP and hydroxyapatite, then, the ACP content represents at least 80%, at least 85%, at least 90%, at least 95%, at least 96%, at least 97%, at least 98% of at least 99% of the calcium phosphates of the composition of the invention.

In a particular embodiment, the composition of the invention comprises ACP and hydroxyapatite, and the ACP content represents at least 80%, at least 85%, at least 90%, at least 95%, at least 96%, at least 97%, at least 98% of at least 99% of the calcium phosphates of the composition of the invention.

In another embodiment, when the ACP content represents at least 80%, at least 85%, at least 90%, at least 95%, at least 96%, at least 97%, at least 98% of at least 99% of the calcium phosphates of the composition of the invention, then, the nanoparticles have a negative surface charge having a ζ-potential in the range from −30 0.0 mV to −3.0 mV, more preferably from −20.0 mV to −5.5 mV, preferably about −10.0 mV.

“Negatively charged nanoparticles with ζ-potential in the above mentioned ranges” means nanoparticles with ζ-potential determined by Electrophoretic Light Scattering (ELS);

Methods for the Preparation of Compositions Comprising Calcium Phosphate Nanoparticles Loaded with a Jasmonate Compound

In a second aspect, the invention relates to method for preparing a composition as defined in the first aspect of the invention comprising:
a) contacting a composition A comprising a calcium salt with a composition B comprising a phosphate under conditions adequate for the formation of a precipitate formed by calcium phosphate nanoparticles;
b) collecting the precipitate obtained in step a),
c) dispersing the precipitate obtained in step b) in an aqueous solvent and
d) contacting the dispersion obtained in step c) with a jasmonate compound.

The term “contacting”, as used herein refers to the process by which the composition A comes into contact with the composition B. The contacting step includes any possible conventional method that allows both compositions to react with each other.

The “adequate conditions” are those known by the person skilled in the art that allows the composition A and B to react and which include the specific concentration of composition A and composition B, temperature, pH and time sufficient to permit the mixing of the components of compositions A and B.

In a particular embodiment, composition A and composition B are mixed at equal volume, that is, at 1:1 (v/v).

In a particular embodiment, the contacting step a) is carried out for a period of between 1 minute and 48 hours, between 1 minute and 24 hours, between 1 minute and 12 hours, between 1 minute and 10 hours, between 1 minute and 5 hours, between 1 minute and 1 hour, preferably between 1 minute and 30 minutes.

In addition, the type of particles formed after mixing composition A and B depends on the time of mixing (i.e., maturation time). Typically, the particles formed immediately after mixing composition A and B, are ACP, which may last in the precipitate for a period of time between 1 minute and 30 minutes, and then transformed into nanocrystalline hydroxyapatite at longer maturation times. Thus, the longer the maturation time, the higher the crystallinity of the nanoparticles. Therefore, depending on the maturation time, the proportion of ACP and hydroxyapatite within the precipitate may vary according to the embodiments already described within the context of the composition of the invention.

The temperature is preferably between 20° C. and 45° C., more preferably between 25° C. and 40° C., even more preferably between 30° C. and 40° C. In preferred embodiment, the temperature is between 30° C. and 40° C., preferably at 37° C.

Step a) may be performed in alkaline media, preferably in a pH range between 8 and 11, more preferably between 9 and 11. When ACP is synthetized and step a) is performed in alkaline media the chemical formula Ca₃(PO₄)2nH₂O is most widely found in the amorphous precipitate. In an embodiment, step a) is performed at pH between 9 and 11 and the temperature is between 37° C. and 50° C. Also, step a) may be performed in acidic media, preferably in a pH range between 4 and 6. In an embodiment, when ACP is synthetized at pH between 4 and 6, then, the formed nanoparticles comprise HPO₄²⁻ ions.

Depending on the pH of the method, Ca/P molar ratio may vary from 1.5 at alkaline pH and 1.15 at acidic pH.

In a particular embodiment, the calcium salt is calcium chloride (CaCl₂) or calcium nitrate (Ca(NO₃)₂) and/or the phosphate is provided as a phosphate salt. Examples of phosphate salts include without limitation K₃PO₄, K₂HPO₄, Na₂HPO₄, Na₃PO₄. In a preferred embodiment the phosphate salt is selected from K₂HPO₄, K₃PO₄, KH₂PO₄, Na₂HPO₄ and Na₃PO₄. In another embodiment the phosphate salt is K₂HPO₄.

In a preferred embodiment, the calcium salt is at a concentration in a range from 0.05 M to 0.4 M, from 0.1 M to 0.3 M, more preferably about 0.2 M. In a particular embodiment, the calcium salt is selected from CaCl₂ and Ca(NO₃)₂. In a particular embodiment the calcium salt is Ca(NO₃)₂ or CaCl₂ at a concentration of 0.2 M. In a preferred embodiment, the calcium salt is Ca(NO₃)₂ at a concentration of 0.2 M.

In an embodiment, the phosphate is at a concentration in the range from 0.05 M to 0.3 M, from 0.1 to 0.2 M, preferable about 0.12 M. In another embodiment, the phosphate is Na₂HPO₄ at a concentration of 0.12 M.

In a particular embodiment, the composition A further comprises a citric acid derivative and the composition B further comprises a carbonate salt.

Suitable citrate acid derivatives and carbonates salts have already been described within the context of the composition of the invention and equally apply to the method of the invention. In a particular embodiment the citric acid derivative is sodium citrate (Na₃Cit).

In another embodiment, the citric acid derivative is at a concentration in a range from 0.05 M to 0.5 from 0.1 to 0.3 M, preferably about 0.2 M. In a preferred embodiment the citric acid derivative is Na₃C₆H₅O₇ at a concentration of 0.2 M.

In a particular embodiment, the carbonate salt concentration is in a range from 0.05 to 0.5 M, from 0.075 to 0.2 M, preferably about 0.1 M. In a preferred embodiment, the carbonate salt is Na₂CO₃ at a concentration of 0.1 M.

In a more particular embodiment, the calcium salt is Ca(NO₃)₂ at a concentration of 0.2 M, the phosphate is Na₂HPO₄ at a concentration of 0.12 M, the citric acid derivative is Na₃C₆H₅O₇ at a concentration of 0.2 M and the carbonate salt is Na₂CO₃ at a concentration of 0.1 M.

The contacting of compositions A and B leads to the formation of a precipitate of calcium phosphate, which is collected in step b). The collecting of the precipitate may be performed by any conventional method known in the art, such as filtration, or evaporation.

Typically, the type of particles formed after the interaction of composition A and B, are ACP. ACP, may transform into hydroxyapatite microcrystalline in the presence of water. The lifetime of the ACP precursor in aqueous solution is a function of the presence of additive molecules and ions, pH, ionic strength, and temperature. The precipitate obtained in step b) is dispersed in an aqueous solution according to the step c) of the method of the invention. As used herein “dispersing” is used as the process by which distributed particles of one material are dispersed in a continuous phase of another material. The two phases may be in the same or different states of matter. Typically, the precipitate is dispersed in an aqueous solvent, more preferably, water.

Optionally, prior to the dispersion step, the precipitate may be washed with ultrapure water by centrifugation, for example at 5000 rpm for 15 min at 18° C. for the removal of non-reacted ions.

At the end of the step of removal of non-reacted ions, a suspension of nanoparticles is obtained that can be subjected to addition of bidistilled water and freeze dried to obtain the calcium phosphate nanoparticles. Alternatively, the product of step b) can be freeze-dried to obtain powders.

Finally, in step d), the dispersion obtained in c) is contacted with different amounts of the jasmonate compound. The contacting is carried out under adequate conditions to allow the adsorption of the jasmonate compound in the surface of the calcium phosphate nanoparticles. Said adequate conditions are known by the skilled in the art and comprise adequate time for the adsorption to take place as well as specific temperature and pH settings.

More particularly, the contacting of step d) may take place for a period of time of between 1 hour and 48 hours, between 5 hours and 40 hours, between 100 hours and hours, more particularly for about 24 hours.

The temperature is preferably between 10° C. and 45° C., more preferably between 15° C. and 40° C., even more preferably between 20° C. and 30° C. In a preferred embodiment, the temperature is between 18° C. and 25° C.

In a particular embodiment, the contacting between the calcium phosphate nanoparticles and the jasmonate compound is performed under agitation.

In a particular embodiment, the ratio of the calcium phosphate nanoparticle obtained in step c) and the jasmonate compound is between 1:1 and 20:1, more preferably 10:1.

Preferably, once finished the contacting period, the nanoparticles loaded with the jasmonate compound are isolated from unbound MeJ by centrifugation (12000 rpm, 15 min, 18° C.) and stored at 4° C.

In a particular embodiment, the ratio of calcium phosphate precipitate to jasmonate compound used in step d) is of between 1:1 and 100:1 (w/w).

The term jasmonate compound has already been defined within the context of the composition of the invention and equally apply to the present case.

In a preferred embodiment, the jasmonate compound is selected from the group consisting of jasmonic acid, 7-iso-jasmonic acid, 9,10-dihydrojasmonic acid, 9,10-dihydroisojasmonic acid, 2,3-didehydrojasmonic acid, 3,4-didehydrojasmonic acid, 3,7-didehydrojasmonic acid, 4,5-didehydrojasmonic acid, 4,5-didehydro-7-isojasmonic acid, cucurbic acid, 6-epi-cucurbic acid, 6-epi-cucurbic acid-lactone, 12-hydroxy-jasmonic acid, 12-hydroxy-jasmonic acid-lactone, 11-hydroxy-jasmonic acid, 8-hydroxy-jasmonic acid, homo-jasmonic acid, dihomo-jasmonic acid, 11-hydroxy-dihomo-jasmonic acid, 8-hydroxydihomo-jasmonic acid, tuberonic acid, tuberonic acid-0-P-glucopyranoside, cucurbic acid-0-P-glucopyranoside, 5,6-didehydro-jasmonic acid, 6,7-didehydro-jasmonic acid, 7,8-didehydro-jasmonic acid, cis-jasmone, dihydrojasmone, and a lower alkyl ester thereof.

In a more preferred embodiment, the jasmonate compound is methyl jasmonate (MeJ).

In a third aspect, the invention relates to a composition obtainable by the process of the second aspect of the invention.

Methods for Inducing a Jasmonate-Dependent Eliciting Response in a Plant Using the Compositions Comprising Calcium Phosphate Nanoparticles Loaded with a Jasmonate Compound

In a fourth aspect, the invention relates to a method for inducing an jasmonate-dependent eliciting response in a plant which comprises applying a composition according to any of the first and third aspects of the invention to the plant, to a propagule thereof or to the soil in which the plant is grown.

The term “eliciting response” refers to the response induced in a plant by an elicitor molecule. “Elicitors” are extrinsic or foreign molecules often associated with plant pests, diseases or synergistic organisms. Elicitor molecules can attach to special receptor proteins located on plant cell membranes. These receptors are able to recognize the molecular pattern of elicitors and trigger intracellular defence signalling via the Octadecanoid pathway. This response results in the enhanced synthesis of metabolites which reduce damage and increase resistance to pest, disease or environmental stress. Elicitors induce structural and/or biochemical responses associated with the expression of plant disease resistance and have been proposed as potential alternatives for effective management of plant diseases. One of the defence mechanisms of plants against pests and pathogens consists on the production of low molecular mass secondary metabolites (i.e., phytoalexins) with antimicrobial activity, such as anthocyanins, stilbenes, and flavonols. These phenolic compounds are also the major responsible of the organoleptic properties of wine and grapes, including wine colour, mouth feel properties and aging potential and stability. Concretely, trans-resveratrol (3,5,4′-trihydroxy-trans-stilbene) has received a widespread attention owing to its anti-inflammatory, anti-carcinogenic, cardio protective-properties. It is indeed considered as one of the major responsible of the health benefits associated to red wines.

Among elicitors, methyl jasmonate (MeJ) or its acidic derivative (jasmonic acid) are hormones, widely found in plant kingdom, involved in plant signalling.3,4 MeJ stimulates the synthesis of defensive compounds and initiates the expression of pathogenesis-related genes involved in systemic acquired resistance and local resistance.4 This induces plant defences against herbivore attack and pathogen infection, and confers tolerance to abiotic stresses such as salinity, drought, high and low temperatures, heavy metal, ozone and ultraviolet radiation. In addition, MeJ induces positive effects on diverse developmental processes of the plants including seed germination, root growth, stamen development, flowering, fruit ripening, and leaf senescence and enhances yields and quality parameters of a large variety of fruits.

The term “plant” includes whole plants, shoot vegetative organs/structures (e.g., leaves, stems and tubers), roots, flowers and floral organs/structures (e.g., bracts, sepals, petals, stamens, carpels, anthers and ovules), seed (including embryo, endosperm, and seed coat) and fruit (the mature ovary), plant tissue (e.g., vascular tissue, ground tissue, and the like) and cells (e.g., guard cells, egg cells, and the like), and progeny of same. The class of plants that can be used in the method of the invention is generally as broad as the class of higher and lower plants amenable to transformation techniques, including angiosperms (monocotyledonous and dicotyledonous plants), gymnosperms, ferns, horsetails, psilophytes, lycophytes, bryophytes, and multicellular algae.

Also, the term plant may include a part thereof, meaning any complete or partial plant, including single cells and cell tissues such as plant cells that are intact in plants, cell clumps and tissue cultures from which plants can be regenerated. Examples of plant parts include, but are not limited to, single cells and tissues from pollen, ovules, leaves, embryos, roots, root tips, anthers, flowers, fruits, stems shoots, and seeds; as well as pollen, ovules, leaves, embryos, roots, root tips, anthers, flowers, fruits, stems, shoots, scions, rootstocks, seeds, protoplasts, calli, and the like.

According to a specific embodiment, applying comprises pre-harvest applying. According to a specific embodiment, said applying comprises post-harvest applying. According to a specific embodiment, said applying comprises pre-harvest applying and not post-harvest applying.

According to a specific embodiment, said applying comprises post-harvest applying and not pre-harvest applying.

According to a specific embodiment, said plant is at a post-blossom stage. According to a specific embodiment, said plant is at a blossom stage. According to a specific embodiment, said plant is at a pre-blossom stage. When indicated a specific stage, the application can be confined only to this stage or to the recited stage and more. For instance, when indicated applying at blossom, applying can be effected at blossom or blossom+post-blossom (i.e., fruit), or pre-blossom+blossom or pre-blossom+blossom+post blossom.

According to a specific embodiment, applying is post-emergence. According to a specific embodiment, the calcium phosphate nanoparticles are formulated in a composition selected from the group consisting of a dip, a spray or a concentrate.

According to a specific embodiment, said applying is in the vicinity of or onto the roots, stems, trunk, seed, fruits or leaves of the plant.

According to a specific embodiment, said applying is by irrigation, drenching, dipping, soaking, injection, coating or spraying.

According to a specific embodiment, said applying is in an open field. According to a specific embodiment, said applying is in a greenhouse.

According to a specific embodiment, said applying is in a storage facility (e.g., dark room, refrigerator).

According to a specific embodiment, said applying is effected once. According to a specific embodiment, said applying comprises repeated application (2 or more applications e.g., every week). Repeated applications are especially envisaged for field/greenhouse treatments.

According to a specific embodiment, said repeated application comprises weekly administration during blossom pre-harvest.

For example, suggested regimen include but are not limited to, spraying plants in open fields and green house, adding to irrigation of plants grown in the open field, green house and in pots, dipping the whole foliage branch in the solution post harvest, adding to vase of cut flowers after harvest and before shipment.

“Propagule” includes all products of meiosis and mitosis, including but not limited to, seed and parts of the plant able to propagate a new plant. For example, propagule includes a shoot, root, or other plant part that is capable of growing into an entire plant. Propagule also includes grafts where one portion of a plant is grafted to another portion of a different plant (even one of a different species) to create a living organism. Propagule also includes all plants and seeds produced by cloning or by bringing together meiotic products, or allowing meiotic products to come together to form an embryo or fertilized egg (naturally or with human intervention).

Soil refers to the mixture of organic matter, minerals, gases, liquids, and organisms that together support life.

In a particular embodiment, the application is carried out by impregnating the leaves of the plant with an aqueous suspension of the nanoparticles.

In a preferred embodiment, the plant is a grapevine.

The term “grapewine” plant refers to any plant of genus Vitis of 79 accepted species of vining plants in the flowering plant family Vitaceae. The genus is made up of species predominantly from the Northern hemisphere. Most Vitis varieties are wind-pollinated with hermaphroditic flowers containing both male and female reproductive structures. These flowers are grouped in bunches called inflorescences. In many species, such as Vitis vinifera, each successfully pollinated flower becomes a grape berry with the inflorescence turning into a cluster of grapes. While the flowers of the grapevines are usually very small, the berries are often large and brightly colored with sweet flavors that attract birds and other animals to disperse the seeds contained within the berries.

In another embodiment, the jasmonate-dependent eliciting response is an increased plant health, tolerance to abiotic stress, regulation of developmental processes, abiotic stress, quality, yield, or output of a desired parameter, a biodefense activity, a reduction of pest infestation and/or the induction of a compound of interest.

Thus, regarding the biodefense activity, the jasmonate compound helps in controlling plant defences against herbivore attack and pathogen infection and activates plant defence mechanisms in response to insect-driven wounding. Also, jasmonates confer tolerance to abiotic stress, including ozone, drought, ultraviolet radiation, high-temperatures, freezing and salinity. In addition, jasmonates regulate various aspects of development, including root growth, stamen development, flowering and senescence.

In a particular embodiment, the compound of interest is a phytoalexin compound.

The term “phytoalexin” as used herein, refers to low molecular weight antimicrobial and often antioxidative substances synthesized de novo by plants as a response to biotic and abiotic stresses and that accumulate rapidly at areas of pathogen infection. Phytoalexins display an enormous diversity belonging to various chemical families such as for instance, phenolics, terpenoids, glycosteroids, and indoles.

“Phenols” of “phenolics”, as used herein, refer to a class of chemical compounds consisting of one or more hydroxyl groups (—OH) bonded directly to an aromatic hydrocarbon group. The simplest is phenol, C₆H₅OH. Phenolic compounds are classified as simple phenols or polyphenols based on the number of phenol units in the molecule.

“Terpenoids” or “isoprenoids”, as used herein, refer to a large and diverse class of naturally occurring organic chemicals derived from the 5-carbon compound isoprene, and the isoprene polymers called terpenes. While sometimes used interchangeably with “terpenes”, terpenoids contain additional functional groups, usually containing oxygen. Terpenoids are the largest class of plant secondary metabolites, representing about 60% of known natural products. Many terpenoids have substantial pharmacological bioactivity and are therefore of interest to medicinal chemists.

The term “alkaloid” refers to a class of basic, naturally occurring organic compounds that contain at least one nitrogen atom. This group also includes some related compounds with neutral and even weakly acidic properties. In addition to carbon, hydrogen and nitrogen, alkaloids may also contain oxygen, sulfur and, more rarely, other elements such as chlorine, bromine, and phosphorus.

The term “glycosteroid”, as used herein, refers to glycosylated steroids. A steroid is a biologically active organic compound with four rings arranged in a specific molecular configuration. The steroid core structure is typically composed of seventeen carbon atoms, bonded in four “fused” rings: three six-member cyclohexane rings and one five-member cyclopentane ring. Steroids vary by the functional groups attached to this four-ring core and by the oxidation state of the rings.

As used herein, the term “indole” refers to an aromatic heterocyclic organic compound with formula C₈H₇N. It has a bicyclic structure, consisting of a six-membered benzene ring fused to a five-membered pyrrole ring.

In a preferred embodiment, the phytoalexin compound is a stilbenes or a stilbene glucoside.

As used herein, stilbenes refer to phenolic compounds found in various families of plants. Some of these secondary metabolites have been recognized as phytoalexins and associated with the defense mechanisms of plants as they are produced after infection by pathogens or exposure to UV radiation and present, defined by two aromatic rings linked by an ethylene bridge. The most known and best characterized stilbene is resveratrol (3,5,4′-trihydroxystilbene). More than 400 stilbene derivatives have been identified. Their structures range from monomers to octamers and carry various substituents at different positions, like glycosyl, hydroxyl, methyl or isopropyl groups. The presence of stilbenes in the human diet is however limited to a few foods such as grapes, red wine, peanuts and some types of berries.

As used herein, the term “stilbene glucoside” or “stilbene glycoside” refers to compounds structurally characterized by the presence of a carbohydrate moiety glycosidically linked to the stilbene skeleton.

Non-limiting examples of stilbenes and stilbene glucosides include, without limitation trans-Resveratrol, Vaticanol C-like isomer, cis-piceid, trans-piceatannol, ampelopsin H, α-viniferin, cis-miyabenol C, cis-resveratrol-3-O-glucoside, trans-piceid, trans-miyabenol C, trans-δ-Viniferin, cis-resveratroloside, (+)-trans-ε-Viniferin, ampelopsin D, trans-ω-Viniferin, cis-ω-Viniferin, cis-Resveratrol, trans-Resveratroloside, Pallidol, Quadrangularin A, Isohopeaphenol, cis-Isorhapontigenin, trans-Isorhapontin, trans-Isorhapontigenin, trans-Pterostilbene, (+)-cis-ε-Viniferin, trans-Astringin, cis-δ-Viniferin, trans-Pinostilbene-4′-O-glucoside, cis-Astringin, trans-Pinostilbene, trans-Rhaponticin, cis-Pinostilbene, Restrytisol, 2,4,6-Trihydroxyphenanthrene-2-O-glucoside, Ampelopsin B, trans-Resveratrol-2-C-glucoside, Viniferin derivative (dimethylated), Isorhapontigen, trans-Resveratrol-10-C-glucoside, trans-Resveratrol-O-glucoside, Leachianol G, Leachianol, Restrytisol A, Ampelopsin A, Pallidol, Caraphenol, Hopeaphenol, Viniferifuran, Diptoindonesin A, Vitisin A (r2-Viniferin), Vitisifuran A, Vitisifuran, trans-Scirpusin A, Vitisin, Ampelopsin C, Maackin A, Viniphenol A, Viniferol A, Viniferol B, Viniferol C, Viniferol D, Malibatol A, Ampelopsin F, Ampelopsin E, Viniferal, Vitisinol E, (+)-trans-ε-Viniferin, Vitisin B (r-Viniferin), trans-Miyabenol C, Vitisinol C, Leachianol G, Leachianol F, Caraphenol B, trans-ε-Viniferin derivative (γ-lactam ring), trans-Resveratrol derivative (γ-lactam ring), (+)-trans-ε-Viniferin, Wilsonol C, Vitisinol, Stenophyllol C, Viniferether A and Viniferether B.

In an embodiment, the stilbene is selected from the group consisting of trans-resveratrol, cis-resveratrol or a mixture thereof and/or wherein the stilbene glucoside is cis-piceid, trans-piceid or a combination thereof.

The term “resveratrol” or “3,4′,5-trihydroxystilbene”, as used herein, refers to a phytoalexin, a non-flavonoid phenolic compound found in many plants species including grapes olives, blackberries, pines, and peanuts. It is a stilbene in which the phenyl groups are substituted at positions 3, 5, and 4′ by hydroxy groups. It is mainly found in the skin of grapes and, as such, is present in varying amounts in red and white wines. Resveratrol exists in two isomeric forms, trans-resveratrol and cis-resveratrol. Trans-resveratrol is highly unstable to UV light and readily isomerizes to the cis form. This isomerization is disadvantageous particularly in the spectrophotometric analysis of trans-resveratrol, in which UV irradiation is used as the detection source. Depending on the solvent trans-resveratrol typically absorbs UV light at 320 and 305 nm and cis-resveratrol absorbs between 280 and 295 nm. Secondary absorbance maxima are observed for both isomers at 210 nm from monosubstituted and disubstituted benzene rings. Isomerization of trans-resveratrol is highly dependent on the sample matrix and storage but typically results in an equilibrium mixture of 90:10, cis to trans, respectively.

The term “piceid” or “3,5,4′-Trihydroxystilbene-3-O-β-D-glucopyranoside” refers to a stilbenoid glucoside which is a major resveratrol derivative in grape juices. It can be found in the bark of Picea sitchensis. It can also be isolated from Reynoutria japonica (syn. Fallopia japonica), the Japanese knotweed (syn. Polygonum cuspidatum). Resveratrol can be produced from piceid via the mold Aspergillus oryzae, as the fungus produces a potent beta-glucosidase. trans-Piceid is the glucoside formed with trans-resveratrol, while cis-piceid is formed with cis-resveratrol.

The invention will be described by way of the following examples, which are to be considered as merely illustrative and not limitative of the scope of the invention.

### EXAMPLES

### Materials and Methods

### Materials

Sodium citrate tribasic dihydrate (Na₃(C₆H₅O₇)·2H₂O, ≥99.0% pure), potassium phosphate dibasic anhydrous (K₂HPO₄, ≥99.0% pure), sodium carbonate (Na₂CO₃, ≥99.0% pure), calcium nitrate tetrahydrate (Ca(NO₃)₂·4H₂O, ≥99.0% pure) and methyl jasmonate (C₁₃H₂₀O₃, 95%, racemic) were purchased from Sigma-Aldrich. All the solutions were prepared with ultrapure water (0.22 μS, 25° C., Milli-Q®, Millipore).

### Synthesis and Characterization of Nano-MeJ

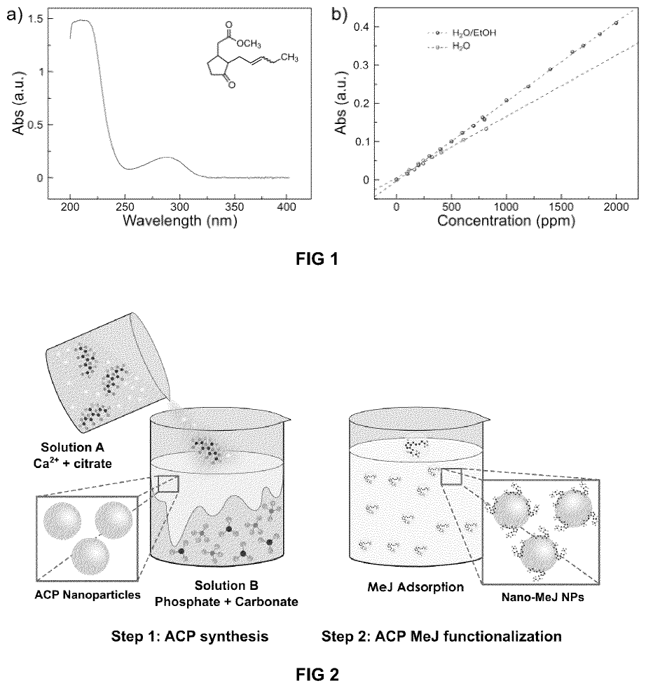

Amorphous calcium phosphate (ACP) nanoparticles were synthesized by a simple batch precipitation method at room temperature, following a protocol previously reported.25 Briefly, two solutions, (A) Ca(NO₃)₂ (0.2 M) and Na₃Cit (0.2 M) and (B) K₂HPO₄ (0.12M) and Na₂CO₃ (0.1 M), were mixed (1:1 v/v, 100 mL total) under agitation for 5 minutes. The precipitates were collected and repeatedly washed with ultrapure water by centrifugation (5000 rpm, 15 min, 18° C.). Afterwards, 200 mg of ACP nanoparticles were dispersed in 10 mL of ultrapure water with vigorous vortex and different amount of MeJ were added to the nanoparticle suspension: 200 mg (Nano-MeJ200), 40 mg (Nano-MeJ40), 20 mg (Nano-MeJ20) and 10 mg (Nano-MeJ10). After 24 hours under agitation at room temperature, nano-MeJ were isolated from unbound MeJ by centrifugation (12000 rpm, 15 min, 18° C.) and stored at 4° C. Small quantities of sample were freeze-dried (Telstar) for further characterization. The amount of non-adsorbed MeJ in collected supernatant was quantified by UV-Spectroscopy (Thermo Spectronic Unicam UV 300, USA) considering the strongest absorption band of MeJ ketone group (λ=291 nm) (FIG. 1). Then, MeJ adsorption efficiency was calculated according to the following equation:

MeJ Adsorp.Eff.(%)=(Initial MeJ (mg)−non adsorbed MeJ (mg))/(Initial MeJ(mg))·100

Where ‘Initial MeJ’ is the mass of MeJ added into solution and ‘non-adsorbed MeJ’ is the mass of MeJ on the collected supernatant.

Fourier transform infrared (FTIR) spectra of nano-MeJ samples were recorded on a Tensor 27 (Bruker, Karlsruhe, Germany) spectrometer. Each powdered sample (2 mg) was mixed with 200 mg of anhydrous potassium bromide (KBr) and pressed at 5 tons into a 12 mm diameter disc using a hydraulic press (Specac). Three KBr pellets were produced for each sample, and a pure KBr disk was used as a blank. The infrared spectra were collected from 400 cm⁻¹ to 4000 cm⁻¹ at a resolution of 4 cm⁻¹. X-ray powder diffraction (XRPD) data were performed on a Bruker D8 Advance diffractometer (from Centre for Scientific Instrumentation of the University of Granada, CIC-UGR) using Cu Kα radiation (λ=1.5406 Å), from 15° to 55° (2θ) with a scan rate of 40 s step-1, step size of 0.020 with a HV generator set at 50 kV and 1 mA. Transmission electron microscopy (TEM) analyses were performed with a LIBRA 120 PLUS instrument (Carl Zeiss SMT, CIC-UGR), operating at 120 kV. Nano-MeJ nanoparticles were ultrasonically dispersed in ethanol, and later, some drops of the slurry were deposited on 200 mesh copper grids covered with thin amorphous carbon films. The evaluation of the chemical composition (Ca, P and K) was performed by inductively coupled plasma optical emission spectrometry (ICP-OES, Optima 8300, PerkinElmer) from CIC-UGR. Firstly, 2 ml of ultrapure nitric acid was used to dissolve 20 mg of the powdered sample. Secondly, the mix was diluted up to 100 mL with Milli-Q water. Three measurements of Ca, P and K content were carried out per each of three replicates. The correspondent emission wavelengths were 766.49 nm (K), 317.93 nm (Ca) and 213.62 nm (P). Nano-MeJ and the naked nanoparticles (control) were suspended in ultrapure water (0.5 mg/mL, 0.1% Tween) to measure the zeta potential with a Litesizer 500 (Anton Paar, Austria) through electrophoretic mobility.

### Stability of the Nano-MeJ Upon Storage

Nano-MeJ was stored at 4° C. and its stability was evaluated after up to 12 months. At specific times, the sample was collected, freeze-dried and characterized by FTIR spectroscopy and X-Ray diffraction.

### In Vitro Cytotoxicity Assay

Mouse skin melanoma (B16-F10, ATCC CRL-6322) cell line was purchased from the Cell Bank of CIC-UGR. B16-F10 cells were expanded in Eagle's minimum essential medium (EMEM) with Earle's balanced salt solution (EBSS) supplemented with 2 mM glutamine, and 10% foetal bovine serum (FBS), 1% nonessential amino acids (NEAA) and 1 mM sodium pyruvate (NaP) at 37° C. in a humidified atmosphere of 5% CO2.

Cells were detached from culture flasks by trypsinization, centrifuged and resuspended. Cell number and viability were assessed with the trypan-blue dye exclusion test. Then, 1.0·10⁴ cells/well were seeded in a 96 flat transparent well and incubated at 37° C. in a humidified atmosphere of 5% CO₂. After 24 hours, different concentrations of MeJ, nano-MeJ and non-functionalized nanoparticles (nano-control) were added. Cells were exposed to equimolar amounts of MeJ, either free MeJ or coupled to nanoparticles (nano-MeJ): 0.25, 0.5, 1, 2, 3, 5, and 10 mM. Nano-control was tested at the same nanoparticle concentrations than nano-MeJ. After 2 days incubation, cell viability was evaluated by MTS assay using CellTiter 96® AQueous One Solution Reagent (Promega, Madison, WI) according to the manufacturer's instructions. Briefly, 20 μL of AQueous One Solution Reagent was added to each well and after 2 h of incubation, the absorbance at 490 nm was measured with a spectrophotometer (Infinite® 200 PRO NanoQuant, CIC-UGR). Viability of parallel cultures of untreated cells was taken as 100% viability and values obtained from the cells undergoing the different treatments (MeJ, Nano-MeJ and Nano-control) were referred to this value. Each experiment was done in triplicate.

### MeJ Release Kinetic in Aqueous Medium

The release kinetic of MeJ at room temperature was followed by Cary 100 UV-Vis spectroscopy (Agilent Technologies, Santa Clara, CA, USA). 550 mg of Nano-MeJ gel were weighed in a quartz cuvette and then, 2 mL of ultrapure water were added carefully to the cuvette. The absorbance at λ=291 nm was measured in continuous each 30 minutes until reaching the plateau. The measurements were performed in triplicates.

### In Vivo Field Experiments on Vineyards

The experiments were conducted in a randomized block design, in which five treatments were applied to three replicates, using 10 vines for each replication. Monastrell (Vitis vinifera L.) grapevines from experimental vineyards located in Cehegin (Murcia, Spain): were sprayed with five treatments, in order to evaluate nano-MeJ efficiency in the field. The treatments applied were the following: aqueous solution of MeJ at concentrations of 5 mM and 10 mM (MeJ5 and MeJ10), aqueous suspension of 3.6 g L-1 of ACP nanoparticles (nano-Control), aqueous suspension of 3.6 g L-1 nano-MeJ (resulting in a total concentration of 1 mM in MeJ) and aqueous solution of only Tween 80 (Control) which is used as wetting agent (0.1 v/v) in all treatments. 200 mL of the product was foliarly applied to each plant at veraison. A second application was performed after 7 days. Then, when grapes reached their optimal maturity they were harvested and transported to the winery for winemaking. Vinifications were made in triplicate in 50-L stainless steel tanks using 50 kg of grapes, which were destemmed, crushed, and sulfited (8 g SO₂/100 kg). Total acidity was corrected to 5.5 g/L with tartaric acid, and selected yeasts were added (Uvaferm VRB, Lallemand, 25 g/hL). The fermentative pomace contact period was 10 days during which the cap was punched down twice a day, and the temperature and must density were recorded. At the end of alcoholic fermentation, wines were pressed at 1.5 bars in a 75 L tank membrane press and packed in bag-in-box for further analysis.

### In Vitro Nano-MeJ Protection Assays

Solutions containing MeJ (10 mM) and nano-MeJ (with a total concentration of 2 mM) were placed on a glass slide in 100 μL drops to emulate the conditions in the field after foliar spray. Both of them were kept at 50° C. during 24 h. At scheduled times, the drops were observed using an iScope (Euromex) microscope, in bright field mode and under 40× objective. After 24 hours, the remained samples were analysed by Raman Spectroscopy (JASCO NRS-5100, Jasco International Co. Ltd, Japan) from CIC-UGR. The excitation line was provided by a diode laser emitting at a wavelength of 785 nm. The detector used is a Peltier cooled charge-couple device (CCD, 1024×256 pixels). Before the measurement, the Raman shift of the spectrometer was calibrated using the 520.7 cm-1 peak of crystalline silicon as standard. Each spectrum corresponds to the average of 3 acquisitions of 100 s each. The spectra were linearly base-line corrected for clarity.

The same experiment was carried out by depositing on a crystallizer 30 drops of 100 μL of each sample to determine the ratio of protection. After 24 hours, MeJ drops were collected with 1 mL of water:ethanol (50:50) solution and the amount of MeJ was measured by UV-Vis spectroscopy (FIG. 1). In the case of nano-MeJ solutions, 5 mL of water was used to recover the drops. The recovered sample was kept in darkness up to 48 hours to ensure the full MeJ dissolution. Then, the sample was centrifuged (12000 rpm, 10 minutes) to remove the nanoparticles before UV-Vis measurements. The ratio of protection (%) was calculated as MeJfinal/MeJinicial×100. Each test was performed in triplicates.

### Stilbene Analysis in Wines

The extraction method used was described by Guerrero et al. with some modifications. Briefly, 5 mL of wine were extracted with 5 mL of diethyl ether to which 25 μL of internal standard (Trans-4-Hydroxistilbene, 98%) were added. Samples were homogeneized with an Ultraturrax T-25 (Jankel Adnand Kunkel, IKA-Labortechnick, Germany) and stirred at 9600 rpm for 1 minute. The solutions were centrifuged (Eppendorf 5810-R centrifuge) at 10000 rpm for 10 minutes at 4° C. The organic phase was dried in a Centrivap concentrator (Centrivap Labconco, USA) and the samples were diluted in 0.5 mL MeOH and filtered through a nylon 0.20 μm filter. During the extraction process, samples were maintained in darkness and at low temperature to avoid possible oxidations and isomerizations.

Stilbenes were identified and quantified by HPLC. Samples were analysed using a Waters2695 system equipped with a mass detector (Acquity QDA Waters). A 5 μm particle size 25×0.4 cm C-18 reversed phase column, Lichrospher 100 RP-18 (Merk, Darmstadt, Germany) was used. The analysis was carried out at a temperature of 25° C. and the injected sample volume was 10 μL. The separation was carried out in a gradient using formic acid (1%) and acetonitrile as mobile phases, with a flow of 1 mL/min. Mass spectrometry (MS) analyses were performed with an electrospray ionisation source (ESI) in negative mode with a sampling frequency of 5 points/s. The capillary and fragmentor potentials were set respectively to 0.8 kV and 40 V. The QDA analyser worked in full scan mode, and the mass range was set at m/z 200-500. Stilbenes were quantified at 320 nm using trans-resveratrol, trans-piceid, piceatannol and ε-viniferin as external standards.

### Statistical Analysis

Statistical comparisons were analysed with GraphPad Prism software (version 6.0) using one-way or two-way ANOVA and Bonferroni's post hoc test. When P-values are lower than 0.05 (i.e., P<0.05), differences in the obtained numerical results were considered statistically significant. The half inhibitory concentrations (IC50) were calculated by the Graph Pad Prism, using the dose-response sigmoidal curves, p<0.05.

### Results

### Synthesis Optimization and Characterization of Nano-MeJ

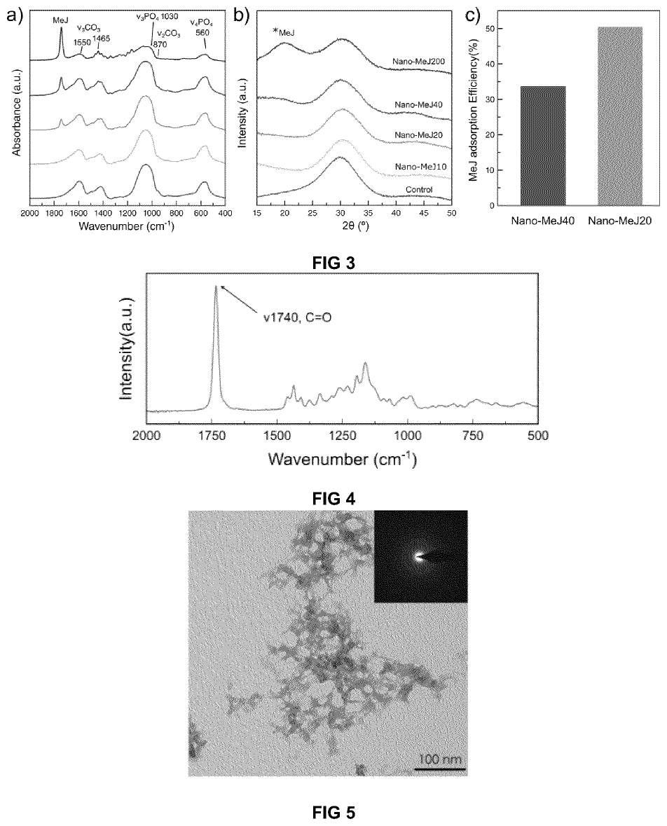

The experimental conditions were optimized with the aim of loading the maximum amount of MeJ on ACP nanoparticles (FIG. 2). To this aim, freshly prepared ACP nanoparticles (200 mg) were incubated with increasing quantities of MeJ: 10 mg (nano-MeJ10), 20 mg (nano-MeJ20), 40 mg (nano-MeJ40) and 200 mg (nano-MeJ200). The FTIR spectrum of nano-MeJ200 (FIG. 3a) shows typical phosphate absorption bands of ACP43 along with a sharp peak at ˜1740 cm-1 attributed to carbonyl (ketone) groups of MeJ (FIG. 4).44 XRD pattern of this sample exhibits two broad bands: one at 30° (2θ) characteristic of ACP and the other at 20° (2θ), due to the diffuse scattering of non-adsorbed MeJ (FIG. 3b, nano-MeJ200). The latter feature was not observed in the XRD patterns of nano-MeJ synthesized with lower MeJ concentrations (FIG. 3b, nano-MeJ40, nano-MeJ20 and nano-Me10), revealing the formation of ACP-MeJ nanocomposites at these weight ratios. Nano-MeJ10 contained very low concentration of MeJ since the band at 1740 cm-1 was practically negligible (FIG. 3a). On the basis of XRD and FTIR results, nano-MeJ40 and nano-MeJ20 composites were selected as the most suitable conditions for further analyses.

The MeJ loading capacity (%) and adsorption efficiency (%) were evaluated by UV-vis spectroscopy (FIG. 1). Nano-MeJ20 and nano-MeJ40 contained similar content of MeJ (6.2±1.7% and 4.7±1.1%, respectively) but the adsorption efficiency was higher for nano-MeJ20 (FIG. 3c). Hence, nano-MeJ20 was selected as the optimal nanocomposite material and hereafter is referred to as nano-MeJ. After the adsorption, the concentration of non-adsorbed MeJ in the supernatant can be directly measured by UV-Vis (FIG. 1). The remaining solution containing non-adsorbed MeJ was used in successive adsorption experiments, so maintaining environmentally sustainable and efficient the whole synthetic process. This is highly relevant when considering the high costs of MeJ and its associated cytoxicity.

TABLE 1
Chemical composition and ζ-potential of nano-MeJ and ACP nanoparticles
(nano-Control). Data are expressed as mean ± standard deviation.

| | Ca^{a} | P^{a} | K^{a} | | ζ^{b} | MeJ^{c} |
|---|---|---|---|---|---|---|
| | (wt. %) | (wt. %) | (wt. %) | Ca/P^{a} | (mV) | (wt. %) |
| Nano-MeJ | 18.02 ± 4.3 | 8.79 ± 1.3 | 0.27 ± 0.01 | 1.57 ± 0.13 | −15.7 ± 0.6 | 6.15 ± 1.71 |
| Nano- | 14.7 ± 0.14 | 8.06 ± 0.1 | 0.46 ± 0.01 | 1.41 ± 0.03 | −10.3 ± 0.7 | — |
| Control | | | | | | |

^{a}Analysed by ICP-OES.
^{b}Analysed by Litesizer 500.
^{c}Estimated by UV-Vis spectroscopy

The compositional analysis of nano-MeJ by ICP-OES indicated a Ca/P molar ratio closed to 1.5 (Table 1), which is the characteristic of ACP. MeJ adsorption therefore did not affect ACP composition. The morphology was neither affected by MeJ adsorption (see TEM analysis in FIG. 5). The ζ-potential of nano-control and nano-MeJ were, respectively, −15.7±0.6 mV and −10.3±0.7 mV (Table 1). The increase in ζ-potential (less negative) can be associated to MeJ adsorption on the ACP surface.

### Stability of Nano-MeJ Upon Storage

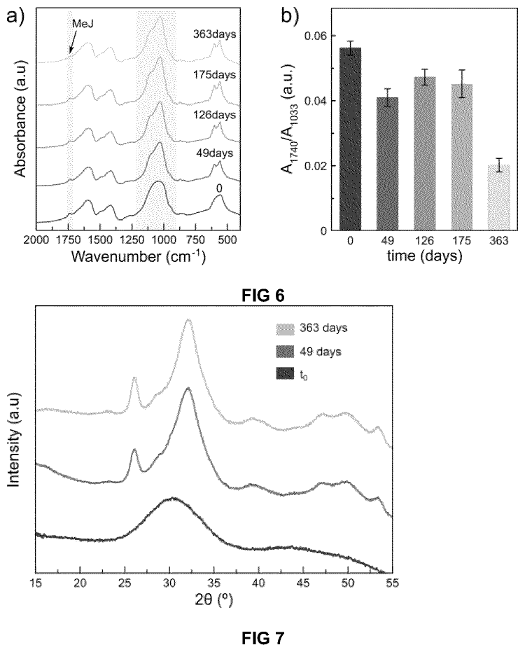

The long-term stability of nano-MeJ stored at 4° C. was monitored by FTIR spectroscopy and X-Ray diffraction (FIG. 6 and FIG. 7). Any remarkable change was found during the first 30 days. FTIR spectrum collected after 49 days showed the sharpening of main phosphate vibrational bands (500-600 and 900-1100 cm⁻¹), suggesting that ACP evolved to poorly crystalline apatite (FIG. 6a). Two broad Bragg peaks at around 26° and 32° (2θ) emerged in the XRD pattern of the same sample (FIG. 7), confirming such conversion. It is well-known that ACP is a transient precursor that converts into the thermodinamically stable phase (apatite or octacalcium phosphate, depending on the experimental conditions). Concomitantly with the ACP-to-Ap conversion, we found a slight decrease in the intensity of MeJ band after 49 days of storage (FIG. 6). This effect is associated to the partial desorption of MeJ, occurring when ACP transforms to Ap. Indeed, ACP is endowed with higher capacity to host exogeneous ions or molecules (e.g. citrate, urea, MeJ) than apatite nanocrystals.^{25,46,48} Despite the slight decrease of MeJ band after 49 days, then it remained constant up to 175 days confirming the long-term chemical stability of nano-MeJ. This aspect is very important for the real application of the product.

### In Vitro Cytotoxicity of Nano-MeJ

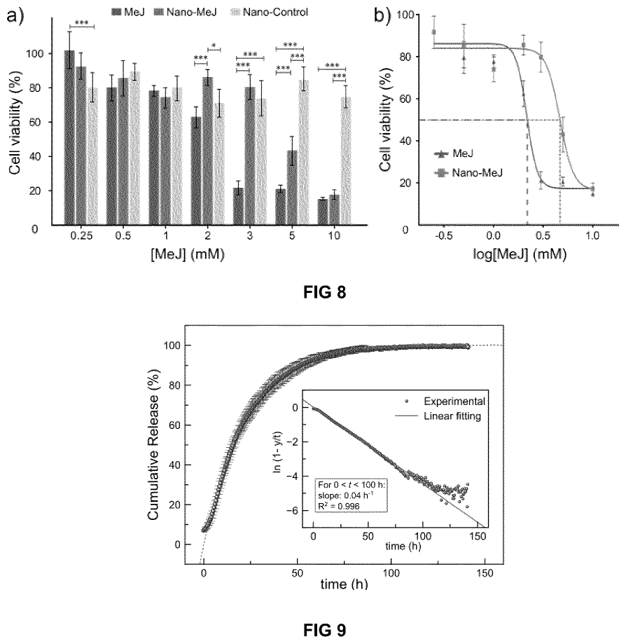

The cytotoxicity of MeJ and nano-MeJ at increasing concentrations was evaluated on B16-F10 cell line by MTS (FIG. 8). Free MeJ showed higher cytotoxicity than nano-MeJ (p<0.001), with IC₅₀ of 2.2 mM and 4.7 mM, respectively. The IC₅₀ value of free MeJ is in agreement with previous results showing that 2.6 mM of MeJ were needed to decrease cell viability of the same cell line in a half. The lower toxicity of MeJ coupled to ACP nanoparticles is remarkably advantageous for the safe handling and usage of MeJ in agriculture. Conversely, ACP nanoparticles (FIG. 8a, Nano-Control) did not affect cell viability at the tested concentrations, as we observed previously.

### Release Kinetics in Aqueous Media

The delivery of MeJ from nanoparticles in water was monitored by UV-Vis during several days. The time-dependent profile is shown in FIG. 9. It follows a gradual and slow release during 80 hours, reaching then a steady state (plateau). The data were fitted to a first-order release model, resulting in a good fit for a release rate of k=0.04 h⁻¹ (R²=0.996, inset of FIG. 9). The low solubility of MeJ in water (340 mg L⁻¹) may explain this slow release profile, comparable to that observed for poor water-soluble drug as doxorubicin from apatite nanoparticles. In fact, the release rate is much slower than that observed for water-soluble species adsorbed on ACP surface, such as urea and nitrate (k(N)=1.97 h⁻¹). MeJ desorption rate is very similar to that of nanoparticle dissolution in water (0.02 h⁻¹<k<0.03 h⁻¹), which indicates that MeJ is delivered upon partial dissolution of the nanoparticles, following thus a similar profile.

### In Vivo Field Experiments on Monastrell Vineyards

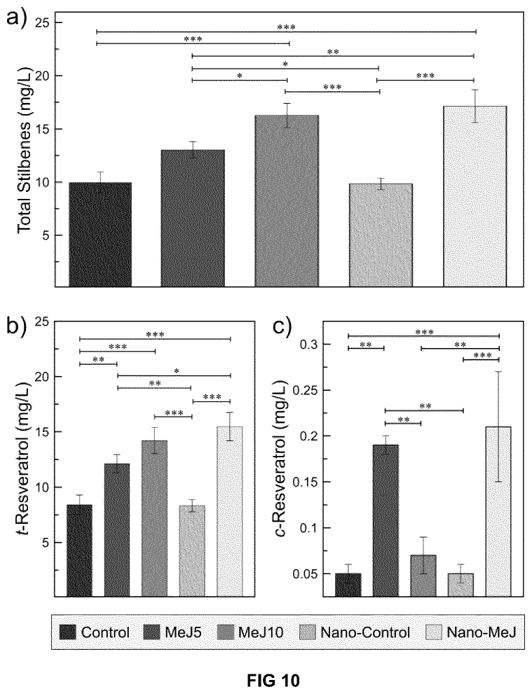

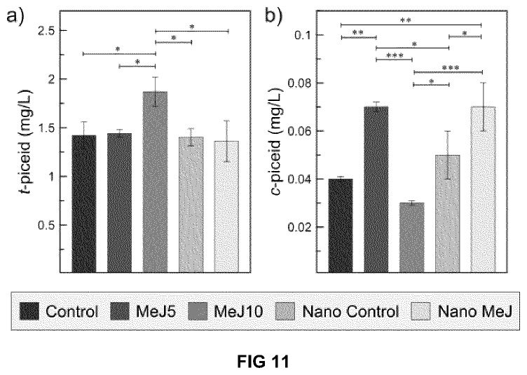

Previous field experiments on Monastrell grapevine revealed that foliar application of 10 mM of MeJ provided a significant increase of total stilbenes in wines in comparison to non-treated (control) plants. Taking into consideration the cytotoxic effects associated to MeJ, we have explored the possibility of reducing MeJ dosage with the nano-MeJ application. During the veraison, the leaves of the Monastrell grapevines were sprayed with aqueous solutions of nano-MeJ with a total MeJ concentration of 1 mM. For the sake of comparison, leaves of different grapevines were sprayed with aqueous solutions of MeJ (with a total concentration of 5 mM or 10 mM). Grapes treated with 10 mM of MeJ (MeJ10) resulted in wines with a significant (p<0.001) increase of the total stilbene concentration with respect to non-treated grapes (control, FIG. 10a). Surprisingly, the application of nano-MeJ allowed a ten-fold reduction of dosage while producing a similar level of stilbene in wines (FIG. 10a). Worth of noting, the reduction of the conventional treatment by 2 times (5 mM MeJ) was not enough to produce the same enhancement in stilbene concentration (MeJ5, FIG. 10a), confirming 10 mM as the minimum concentration to observe important effects when the elicitor is conventionally applied. These important effects were not observed when the plants were treated with naked ACP nanoparticles (nano-Control, FIG. 10a), which indicates that nanoparticles by itself do not stimulate the plants to trigger stilbene production.

The concentration of stilbene phenolic compounds in grapes and wines depends on multiple factors including intrinsic properties of grape variety, climate, growing conditions, harvest year and enological procedures. In fact, Monastrell grapes are considered as a high resveratrol producer. In this study, trans-resveratrol was the major stilbene found in wine (FIG. 10 and FIG. 11), comprising around the 90% of the total stilbenes (FIG. 10a,b). All the MeJ-based treatments produced a substantial increase of trans-resveratrol concentrations in wine respect to the controls (FIG. 10b). Regarding other important stilbenes, nano-MeJ increased cis-, trans-piceid and cis-resveratrol concentrations in wine, in the same extent than conventional MeJ treatments (FIG. 10 and FIG. 11). The contents in resveratrol and piceid isomers in wines obtained from the nano-Control did not show significant differences respect to control wines (FIG. 10 and FIG. 11), confirming the null effect of the naked nanoparticles on stilbene production.

### Protection and Retention of MeJ

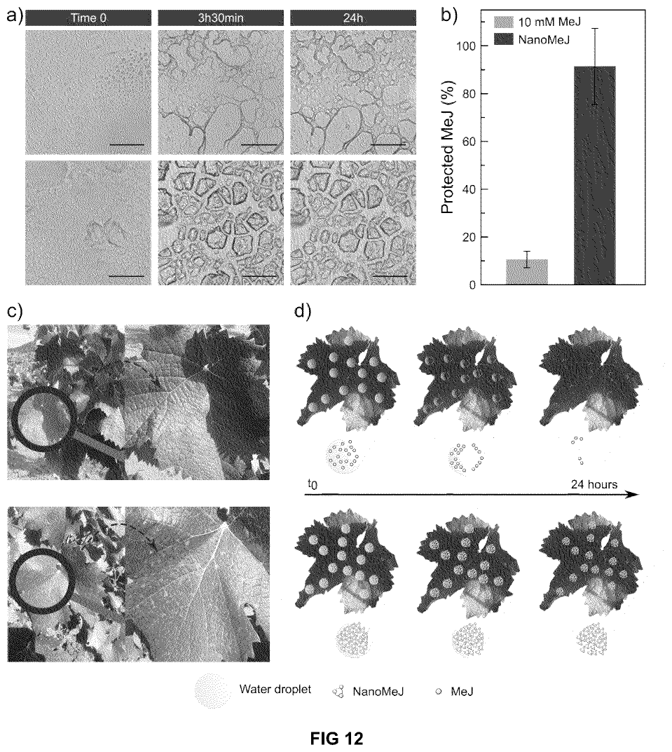

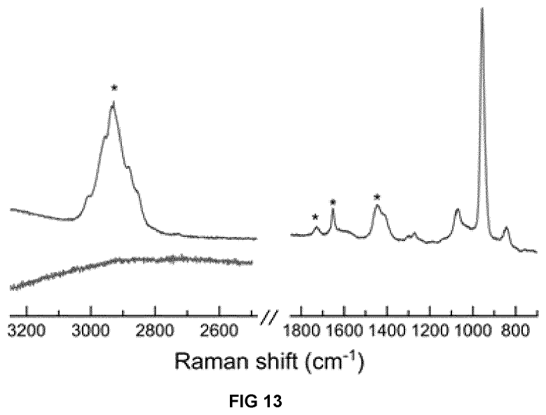

With the aim of explaining the interesting in vivo results, we studied the evolution of MeJ and nano-MeJ in aqueous droplets simulating the conditions occurring in the fields after spraying the leaves. The evolution of the drops was followed by optical microscopy. Micron-sized micelles were found under the microscope soon after the deposition of the drops containing 10 mM MeJ (FIG. 12a, top, t₀). These drops were completely dried after few hours at 50° C., remaining a holey microstructure with oily appearance that did not change after 24 hours (FIG. 12a, top). Raman micro-analysis on different zones of this microstructure (FIG. 13) did not show signals assignable to MeJ, suggesting that MeJ was evaporated after 24 hours. To confirm this hypothesis, the experiment was repeated with 20 droplets (100 μL each) of a solution 10 mM MeJ. MeJ concentration was quantified by UV-Vis spectroscopy after 24 hours at 50° C. Only a small percentage of MeJ (11%) remained in the glass surface (FIG. 12c), confirming the previous observations.

On the other hand, nano-MeJ droplets showed a different behaviour. Drops of nano-MeJ contained floating microparticles as the result of nanoparticle aggregation (FIG. 12a, bottom, to). In this case, micelles of MeJ were not found. The drop was completely dried after 3 hours and 30 minutes at 50° C. and the nano-MeJ aggregates settled on the glass surface (FIG. 12a, bottom). Raman micro-analysis of the mineral aggregates, which remained unaltered during several days at 50° C., confirmed the presence of MeJ (FIG. 13). Indeed, 90% of initial MeJ remained on the glass after 24 hours at 50° C. (FIG. 12b).

A similar behaviour was observed on the surface of the grapevine leaves (FIG. 12c). Photographs of the leaves captured several hours after the treatment with nano-MeJ showed white spots of mineral deposits, which were not observed on the leaves treated with MeJ solutions (FIG. 12c). These results suggest that ACP nanoparticles protect the elicitor against evaporation and/or thermal degradation, prolonging its shelf life on the leaves (FIG. 12d). This favours MeJ absorption through the leaves likely resulting in the efficiency increase observed when using the nanoparticles in the in vivo field experiments.

1. A composition comprising calcium phosphate nanoparticles loaded with a jasmonate compound.

2. The composition according to claim 1, wherein the jasmonate compound is selected from the group consisting of jasmonic acid, 7-iso-jasmonic acid, 9,10-dihydrojasmonic acid, 9,10-dihydroisojasmonic acid, 2,3-didehydrojasmonic acid, 3,4-didehydrojasmonic acid, 3,7-didehydrojasmonic acid, 4,5-didehydrojasmonic acid, 4,5-didehydro-7-isojasmonic acid, cucurbic acid, 6-epi-cucurbic acid, 6-epi-cucurbic acid-lactone, 12-hydroxy-jasmonic acid, 12-hydroxy-jasmonic acid-lactone, 11-hydroxy-jasmonic acid, 8-hydroxy-jasmonic acid, homo-jasmonic acid, dihomo-jasmonic acid, 11-hydroxy-dihomo-jasmonic acid, 8-hydroxydihomo-jasmonic acid, tuberonic acid, tuberonic acid-0-P-glucopyranoside, cucurbic acid-0-P-glucopyranoside, 5,6-didehydro-jasmonic acid, 6,7-didehydro-jasmonic acid, 7,8-didehydro-jasmonic acid, cis-jasmone, dihydrojasmone, and a lower alkyl ester thereof.

3. The composition according to claim 1, wherein the jasmonate compound is methyl jasmonate (MeJ).

4. The composition according to claim 1, wherein the ratio of the nanoparticles and the jasmonate compound is between 1:1 and 20:1 (w/w).

5. (canceled)

6. The composition according to claim 1, wherein the calcium phosphate is amorphous calcium phosphate (ACP) and wherein the nanoparticles further comprise a citric acid derivative and carbonate salt.

7. The composition according to claim 6, wherein the citric acid derivative is sodium citrate (Na₃Cit) and wherein the carbonate salt is sodium carbonate (Na₂CO₃).

8. A method for preparing a composition as defined in claim 1 comprising:
a) contacting a composition A comprising a calcium salt with a composition B comprising a phosphate under conditions adequate for the formation of a precipitate formed by calcium phosphate nanoparticles;
b) collecting the precipitate obtained in step a),
c) dispersing the precipitate obtained in step b) in an aqueous solvent and
d) contacting the dispersion obtained in step c) with a jasmonate compound.

9. The method according to claim 8, wherein the calcium salt is calcium chloride (CaCl₂)) or calcium nitrate (Ca(NO₃)₂) and/or wherein the phosphate is provided as a phosphate salt.

10. The method according to claim 9, wherein the phosphate salt is selected from K₂HPO₄, K₃PO₄, KH₂PO₄, Na₂HPO₄ and Na₃PO₄.

11. The method according to claim 8 wherein the ratio of calcium phosphate precipitate to MeJ used in step d) is of between 1:1 and 100:1 (w/w).

12. The method according to claim 8, wherein composition A further comprises a citric acid derivative and composition B further comprises a carbonate salt.

13. The method according to claim 12, wherein the citric acid derivative is sodium citrate (Na₃Cit) and wherein the carbonate salt is sodium carbonate (NaCO₃).

14. The method according to claim 8 wherein the calcium salt is at a concentration of 0.2 M and the phosphate is at a concentration of 0.12 M, and wherein the citric acid derivative is at a concentration of 0.2 M and the carbonate salt is at a concentration of 0.1 M.

15. (canceled)

16. The method according to claim 8 wherein the jasmonate compound is methyl jasmonate (MeJ).

17. The method according to claim 8, wherein the ratio of the calcium phosphate nanoparticles obtained in step c) and the jasmonate compound is between 1:1 and 20:1.

18. (canceled)

19. A method for inducing a jasmonate-dependent eliciting response in a plant which comprises applying a composition according to claim 1 to the plant, to a propagule thereof or to the soil in which the plant is grown.

20. The method according to claim 19 wherein the application is carried out by impregnating the leaves of the plant with an aqueous suspension of the nanoparticles.

21. (canceled)

22. The method according to claim 19 wherein the jasmonate-dependent eliciting response is an increased plant health, tolerance to abiotic stress, regulation of developmental processes, abiotic stress, quality, yield, or output of a desired parameter and a biodefense activity, a reduction of pest infestation and/or the induction of a compound of interest.

23. The method of claim 22 wherein the compound of interest is a phytoalexin compound.

24. The method according to claim 22 wherein the compound of interest is a phytoalexin compound selected from a stilbene or a stilbene glucoside.

25. (canceled)
